(19) United States
(12) Patent Application Publication
(10) Pub. No.: US 2015/0289173 A1
(43) Pub. Date: Oct. 8, 2015

(54) SYSTEMS AND METHODS FOR ENHANCED CELL RESELECTION

(71) Applicant: QUALCOMM Incorporated, San Diego, CA (US)

(72) Inventors: Kunal Tyagi, Hyderabad (IN); Siddhant Mehrotra, Hyderabad (IN); Ravi Kanth Kotreka, Hyderabad (IN); Pankaj Bansal, Hyderabad (IN); Manjunatha Subbamma Ananda, Chickballapur (IN); Divaydeep Sikri, Farnborough (GB); Cetin Altan, Farnborough (GB); Abeezar Burhan, Ickenham (GB)

(73) Assignee: QUALCOMM Incorporated, San Diego, CA (US)

(21) Appl. No.: 14/245,665

(22) Filed: Apr. 4, 2014

(51) Int. Cl. H04W 36/00

(52) U.S. Cl. CPC H04W 36/0061; H04W 36/34

(57) ABSTRACT

A method for performing cell reselection by a wireless communication device is described. The method includes monitoring one or more neighbor cells of a same radio access technology as a serving cell while camped on the serving cell. The method also includes determining that reselection criteria is met for a target cell. The method further includes starting a reselection timer for the target cell. The method additionally includes determining whether to perform reselection to the target cell based on a target cell signal to noise ratio (SNR) and a serving cell SNR.

### TECHNICAL FIELD

The present disclosure relates generally to communication systems. More specifically, the present disclosure relates to systems and methods for enhanced cell reselection.

### BACKGROUND

Wireless communication systems have become an important means by which many people worldwide have come to communicate. A wireless communication system may provide communication for a number of wireless communication devices, each of which may be serviced by one or more base stations.

Sometimes a wireless communication device will switch from one cell to a target cell. This may be referred to as cell reselection. Benefits may be realized by considering interference levels on the target cell during cell reselection. Additional benefits may be realized by determining the best cell for reselection when multiple cells are available.

### SUMMARY

A method for performing cell reselection by a wireless communication device is described. The method includes monitoring one or more neighbor cells of a same radio access technology as a serving cell while camped on the serving cell. The method also includes determining that reselection criteria is met for a target cell. The method further includes starting a reselection timer for the target cell. The method additionally includes determining whether to perform reselection to the target cell based on a target cell signal to noise ratio (SNR) and a serving cell SNR.

A neighbor cell may be the target cell. The radio access technology may be Global System for Mobile Communications (GSM). The reselection criteria may be based on at least one of a C1 criterion and a C2 criterion. One or more control channels may be used to determine the reselection criteria.

The method may also include measuring the target cell SNR on a nearest burst of the target cell for at least one discontinuous reception (DRX) cycle of the serving cell. The method may further include measuring the target cell SNR during at least one paging channel (PCH) decode on the serving cell. The method may also include adding a penalty time to the reselection timer upon expiration of the reselection timer if the target cell SNR is less than a threshold or less than the serving cell SNR. The penalty time may be a DRX cycle length of the serving cell.

The method may also include determining that reselection criteria is met upon expiration of the reselection timer. The method may further include acquiring the target cell SNR by decoding an immediately available control channel. The method may additionally include performing reselection to the target cell when the target cell SNR is above a threshold of a serving cell SNR.

The method may also include determining that the reselection timer for the target cell has expired. The method may further include comparing, in response to determining that the reselection timer for the target cell has expired, reselection criteria for the target cell with reselection criteria for at least one other neighbor cell that has a running reselection timer that has elapsed more than an intermediate time. The method may additionally include determining whether to perform reselection to the target cell or the at least one other neighbor cell based on the comparison. Determining whether to perform reselection to the target cell or the at least one other neighbor cell may include determining to perform reselection to the target cell or the at least one other neighbor cell with the highest reselection criteria. The method may also include performing reselection to the target cell or the at least one other neighbor cell with the highest reselection criteria.

The method may also include determining that the reselection timer for the target cell has expired. The method may further include comparing, in response to determining that the reselection timer for the target cell has expired, the target cell SNR for the target cell with a neighbor cell SNR for at least one other neighbor cell that has a running reselection timer that has elapsed more than an intermediate time. The method may additionally include determining whether to perform reselection to the target cell or the at least one other neighbor cell based on the comparison.

The method may also include determining whether the target cell SNR is greater than an SNR threshold. The method may further include determining whether a receive power of the target cell is greater than a received signal strength indicator (RSSI) threshold. The method may additionally include marking the target cell as a reselection candidate if the target cell SNR is greater than the SNR threshold and the receive power of the target cell is greater than the RSSI threshold. The method may also include marking the target cell as an invalid reselection candidate if the target cell SNR is not greater than the SNR threshold or the receive power of the target cell is not greater than the RSSI threshold. The method may further include reacquiring the target cell SNR and the receive power of the target cell for a set period of time.

An apparatus for performing cell reselection is also described. The apparatus includes a processor, memory in electronic communication with the processor and instructions stored in the memory, the instructions being executable by the processor. The apparatus monitors one or more neighbor cells of a same radio access technology as a serving cell while camped on the serving cell. The apparatus determines that reselection criteria is met for a target cell. The apparatus starts a reselection timer for the target cell. The apparatus determines whether to perform reselection to the target cell based on a target cell SNR and a serving cell SNR.

A wireless communication device for performing cell reselection is also described. The wireless communication device includes means for monitoring one or more neighbor cells of a same radio access technology as a serving cell while camped on the serving cell. The wireless communication device also includes means for determining that reselection criteria is met for a target cell. The wireless communication device further includes means for starting a reselection timer for the target cell. The wireless communication device additionally includes means for determining whether to perform reselection to the target cell based on a target cell SNR and a serving cell SNR.

A computer-program product for performing cell reselection is also described. The computer-program product includes a non-transitory computer-readable medium having instructions thereon. The instructions include code for causing a wireless communication device to monitor one or more neighbor cells of a same radio access technology as a serving cell while camped on the serving cell. The instructions also include code for causing the wireless communication device to determine that reselection criteria is met for a target cell. The instructions further include code for causing the wireless communication device to start a reselection timer for the target cell. The instructions additionally include code for causing the wireless communication device to determine whether to perform reselection to the target cell based on a target cell SNR and a serving cell SNR.

### BRIEF DESCRIPTION OF THE DRAWINGS

FIG. 1 is a block diagram illustrating a wireless communication system with a wireless communication device, a serving cell and one or more neighbor cells;

FIG. 2 is a flow diagram of a method for performing enhanced cell reselection;

FIG. 3 is a block diagram illustrating a radio network operating in accordance with the described systems and methods;

FIG. 4 is a block diagram illustrating a configuration of a wireless communication system for performing enhanced cell reselection;

FIG. 5 is a flow diagram illustrating a detailed configuration of a method for performing enhanced cell reselection;

FIG. 6 is a block diagram illustrating another configuration of a wireless communication system for performing enhanced cell reselection;

FIG. 7 is a flow diagram illustrating another detailed configuration of a method for performing enhanced cell reselection;

FIG. 8 is a flow diagram illustrating yet another detailed configuration of a method for performing enhanced cell reselection;

FIG. 9 illustrates certain components that may be included within a wireless communication device;

FIG. 10 illustrates certain components that may be included within a base station;

FIG. 11 is a flow diagram illustrating a method for performing enhanced cell reselection based on a target cell SNR and receive (Rx) power; and

FIG. 12 is a flow diagram illustrating a more detailed configuration of a method for performing enhanced cell reselection based on a target cell SNR and Rx power.

### DETAILED DESCRIPTION

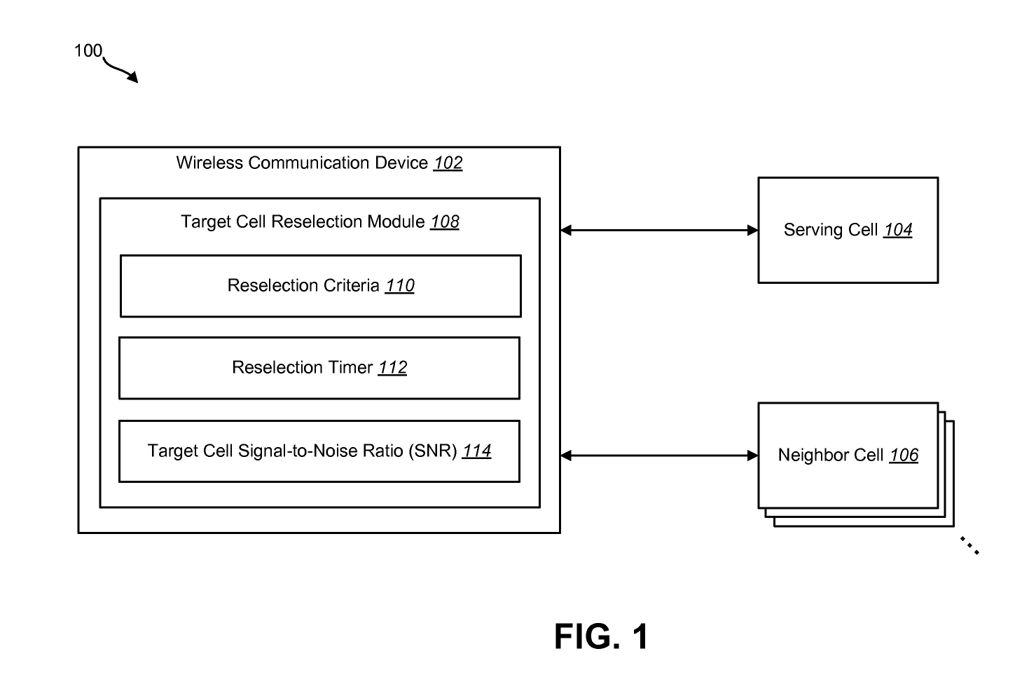

FIG. 1 is a block diagram illustrating a wireless communication system 100 with a wireless communication device 102, a serving cell 104 and one or more neighbor cells 106. Wireless communication systems 100 are widely deployed to provide various types of communication content such as voice, data, and so on. Accelerated cell reselection may be performed on the wireless communication system 100 according to the systems and methods described herein.

The serving cell 104 and the one or more neighbor cells 106 may be provided by a base station. The term “cell” can refer to a base station and/or the coverage area of a base station depending on the context in which the term is used. A base station is a station that may communicate with one or more wireless communication devices 102. A base station may also be referred to as, and may include some or all of the functionality of an access point, a broadcast transmitter, a NodeB, an evolved NodeB, a base transceiver station, etc. The term “base station” will be used herein. Each base station may provide communication coverage for a particular geographic area. A base station may provide communication coverage for one or more wireless communication devices 102.

A base station may provide one or more cells. For example, a first base station may provide a serving cell 104 and a second base station may provide a neighbor cell 106. In another configuration, a single base station may provide both a serving cell 104 and one or more neighbor cells 106.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may also be referred to as a “network” or “wireless network.” The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102 or base station) to extract transmit beamforming gain from communications received by the transmitting wireless device.

The wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems, and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, an appliance (e.g., dishwasher, refrigerator, laundry machine, etc.), a sensor, a wearable computing device (e.g., a smartwatch, a health or fitness tracker, etc.), a vending machine, etc.

A wireless communication device 102 may communicate with zero, one or multiple base stations on the downlink and/or uplink at any given moment. The downlink (or forward link) refers to the communication link from a base station to a wireless communication device 102, and the uplink (or reverse link) refers to the communication link from a wireless communication device 102 to a base station.

The wireless communication device 102 may be camped on the serving cell 104. The term “camp” refers to a process in which the wireless communication device 102 monitors a cell for system information and paging information. The wireless communication device 102 may receive paging information on a paging channel. The cell on which the wireless communication device 102 is camped is referred to as the serving cell 104.

While camped on the serving cell 104, the wireless communication device 102 may be tuned to the paging channel (PCH) of the serving cell 104. The wireless communication device 102 may receive system information from the network 100 (e.g., public land mobile network (PLMN)). If the network 100 receives a call for the wireless communication device 102, the network 100 may know (in most cases) the registration area of the cell in which the wireless communication device 102 is camped. The network 100 can then send a paging message for the wireless communication device 102 on paging channels of all the cells in the registration area. The wireless communication device 102 may then receive the paging message on the paging channel of a cell in that registration area.

Furthermore, the wireless communication device 102 may receive cell broadcast services. In one scenario, the wireless communication device 102 may receive neighbor cell 106 information from the serving cell 104. The neighbor cell 106 information may inform the wireless communication device 102 about neighbor cells 106. In one configuration, the neighbor cell 106 information may be included in a system information type 2 (SI2) message sent from the serving cell 104 to the wireless communication device 102.

The wireless communication device 102 may receive system information from a neighbor cell 106 on a broadcast channel of the neighbor cell 106. The system information may include one of a system information type 3 (SI3) message or a system information type 4 (SI4) message. If the wireless communication device 102 receives either an SI3 message or an SI4 message, then the wireless communication device 102 knows that the neighbor cell 106 is available and may perform cell reselection measurements using the system information.

While camped on the serving cell 104, the wireless communication device 102 may monitor the broadcast channel of the neighbor cells 106 to determine whether to perform a cell reselection. Cell reselection may be performed to ensure that the wireless communication device 102 is on the best carrier available. In some configurations, cell reselection may be performed when any of the neighbor cells 106 meet cell reselection criteria 110 based on the system information acquired from the broadcast channel of the neighbor cells. For example, if the wireless communication device 102 determines that cell power is beyond a certain threshold, the wireless communication device 102 may initiate cell reselection. The wireless communication device 102 may also determine that another cell reading is better in terms of signal power than the signal power of the serving cell 104. For instance, when the wireless communication device 102 is moving from the coverage area of the serving cell 104 into an area where a neighbor cell 106 is better, the wireless communication device 102 may determine that the neighbor cell 106 signal power is better and the cell reselection procedure may begin.

The wireless communication device 102 may determine that it should perform a reselection to a target cell from the serving cell 104. As used herein, a “target cell” is a neighbor cell 106 that is a candidate for reselection. The wireless communication device 102 may evaluate whether a neighbor cell 106 is a cell reselection candidate (e.g., target cell) based on the acquired system information. One or more control channels may be used to determine the reselection criteria 110. The wireless communication device 102 may determine that the cell reselection criteria 110 are met for the target cell based on parameters included in the system information.

According to one approach for a cell reselection procedure, reselection may be based on one or more cell reselection criteria 110. For a GSM network, the cell reselection criteria 110 may be a C1 criterion or a C2 criterion that is determined for a neighbor cell 106. While camped on a serving cell 104, the wireless communication device 102 may monitor one or more neighbor cells 106 to determine a target cell for reselection. In one configuration, a C1 criterion (also referred to as a path loss criterion parameter) may be determined according to Equation (1).

C1=(A−max(B,0)) (1)

In Equation (1), A=RLA_C−RXLEV_ACCESS_MIN, where RLA_C is an average of received signal levels for a cell and RXLEV_ACCESS_MIN is the minimum received signal level (RXLEV) at the wireless communication device 102 required for access to the cell. Furthermore, in Equation (1), B=MS_TXPWR_MAX_CCH−P, where MS_TXPWR_MAX_CCH is the maximum transmission power level the wireless communication device 102 may use when accessing the cell and P is the maximum radio frequency (RF) output power of the wireless communication device 102. All values in Equation (1) may be expressed in dBm. In one configuration, the C1 criterion is satisfied if C1 is greater than 0.

The C2 criterion may be used to rank one or more cells (e.g., serving cell 104 and neighbor cells 106) in a cell reselection process. In one configuration, C2=C1+CELL_RESELECT_OFFSET, where CELL_RESELECT_OFFSET is a parameter that is used to prioritize one cell in relation to other cells.

According to one approach to cell reselection, the wireless communication device 102 may periodically compute the values of the reselection criteria 110 (e.g., C1 and/or C2) for the serving cell 104 and the one or more neighbor cells 106. For example, the target cell reselection module 108 may compute the value of C1 and/or C2 at least every 5 seconds. In one case, cell-reselection may be triggered if the C2 criterion for a neighbor cell 106 is higher than the serving cell 104 for a period of time (e.g., 5 seconds).

The cell reselection procedure in GSM/GERAN networks is predominantly carried out using the received signal strength indicator (RSSI) and/or RXLEV of the carriers deployed. As described above, the RXLEV value is directly fed into calculation of the reselection criteria 110 that assists the wireless communication device 102 in making a decision before proceeding with cell reselection.

Though the reselection criteria 110 may be sufficient in cases where the network deployments are well coordinated in terms of frequency deployment such that there is least or minimal interference from one cell to the other. However, actual network deployments typically do not have such careful and precise planning. Known wireless communication device 102 design does not take the interference into consideration for the reselection criteria 110.

The wireless communication device 102 may waste time and battery in reselecting to a target cell whose RSSI/RXLEV is better than the serving cell 104, but does not account for the interference levels on the target cell. Therefore, the wireless communication device 102 may proceed with a reselection to the target cell but may fail to latch on to the new cell due to control channel decode failures on the target cell caused by high interference (low target cell SNR 114). This scenario may result in low throughput, low page performance and unnecessary reselection, leading to wastage of battery. Furthermore, these problems may be compounded in a multi-subscriber identity module (SIM) device, leading to service outage on other subscriptions.

According to one approach for a cell reselection procedure, once reselection is triggered, common control channel (CCCH) failures may occur due to a poor signal to noise ratio (SNR) on the target cell. This may result in the wireless communication device 102 being unable to decode a broadcast control channel (BCCH), which may lead to reselection failure. Such an approach for cell reselection does not account for interference levels on the target cell. For example, this approach for cell reselection does not account for the target cell SNR 114 during the reselection determination.

To improve cell reselection, a target cell reselection module 108 may perform enhanced cell reselection. If the wireless communication device 102 determines that reselection criteria 110 is met for a target cell and starts a reselection timer 112 for the target cell, the target cell reselection module 108 may perform reselection to the target cell based on the signal to noise ratio (SNR) of the target cell (e.g., target cell SNR 114). The wireless communication device 102 may have multiple reselection timers 112 running corresponding to multiple monitored neighbor cells 106.

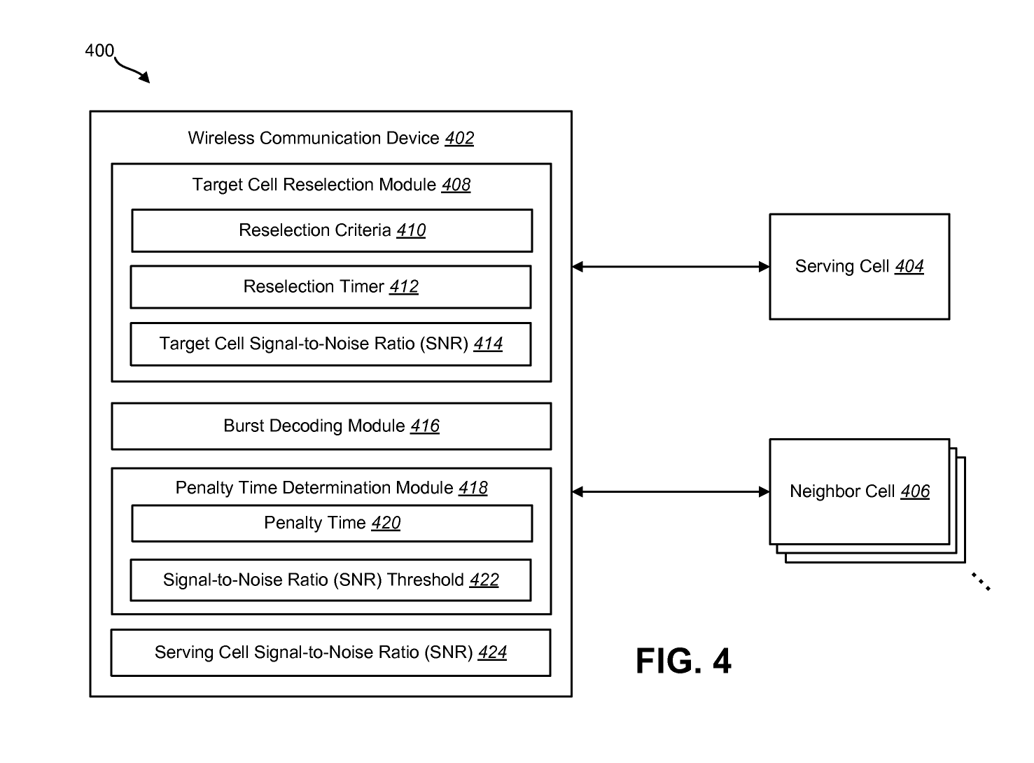

In one configuration, the target cell reselection module 108 may measure the target cell SNR 114 by decoding a nearest burst of the target cell. The target cell reselection module 108 may add a penalty time to the reselection timer 112 if the target cell SNR 114 is less than the serving cell SNR and a defined SNR threshold. This may be accomplished as described below in connection with FIG. 4. The target cell reselection module 108 may then continue to monitor the target cell SNR 114 during the penalty time.

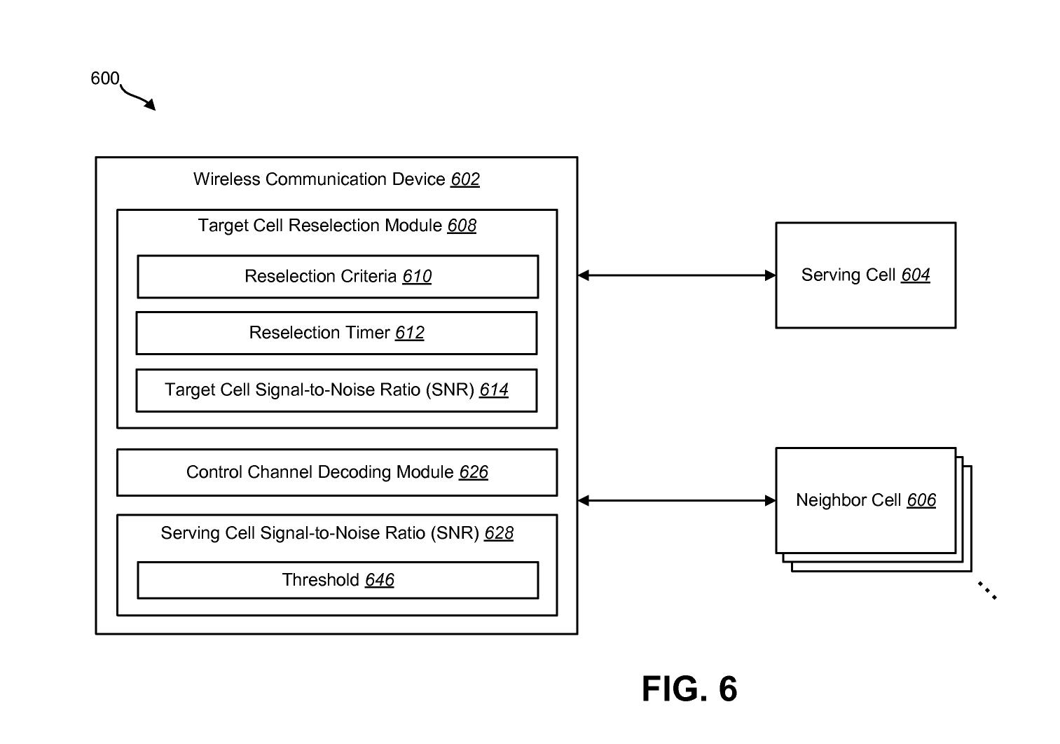

In another configuration, upon expiration of the reselection timer 112 for a target cell, the target cell reselection module 108 may acquire the target cell SNR 114 by decoding an immediately available control channel of the target cell. The target cell reselection module 108 may perform reselection to the target cell if the target cell SNR 114 is above a threshold of the serving cell SNR. This may be accomplished as described below in connection with FIG. 6.

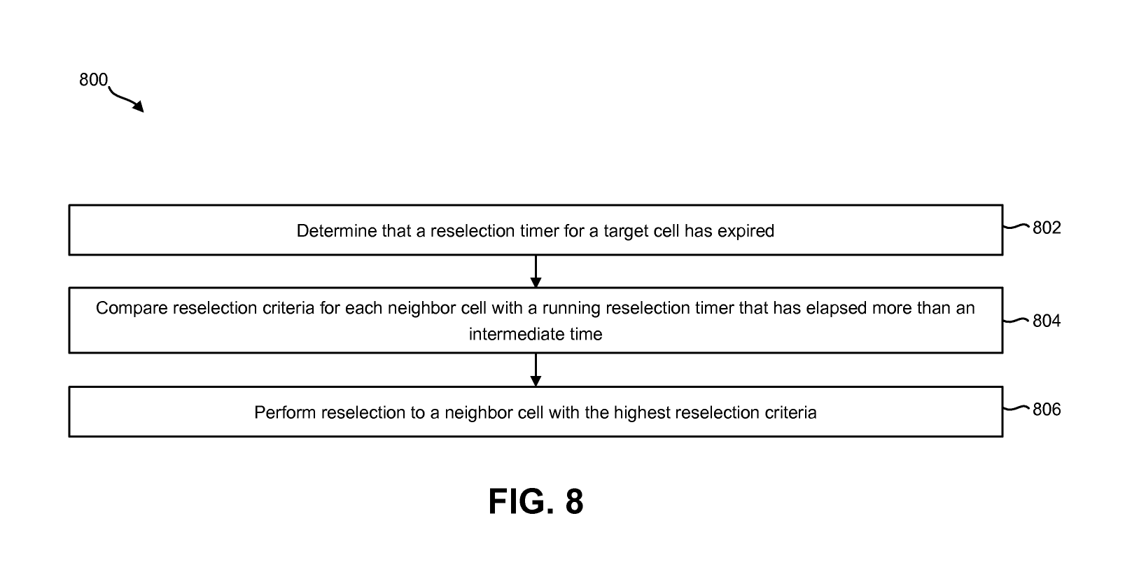

In yet another configuration, upon expiration of the reselection timer 112, the target cell reselection module 108 may compare reselection criteria 110 for each neighbor cell 106 that has a running reselection timer 112 that has elapsed more than an intermediate time. The target cell reselection module 108 may then perform reselection to a neighbor cell 106 with the highest reselection criteria 110. This may be accomplished as described below in connection with FIG. 8.

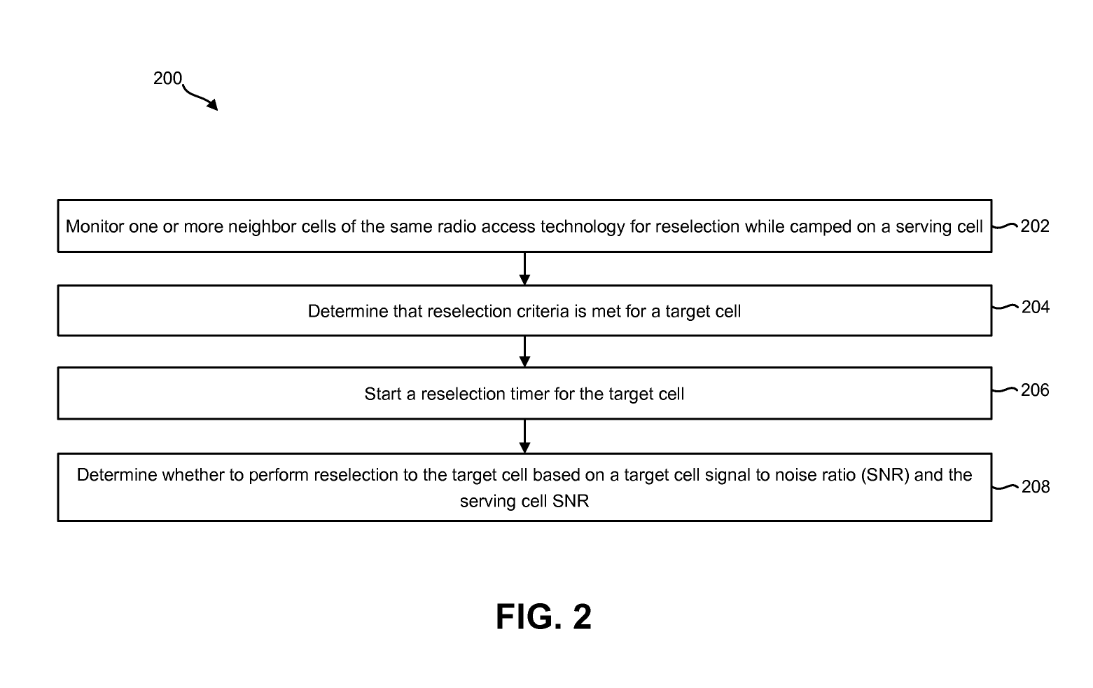

FIG. 2 is a flow diagram of a method 200 for performing enhanced cell reselection. The method 200 may be performed by a wireless communication device 102. The wireless communication device 102 may be camped on a serving cell 104.

The wireless communication device 102 may monitor 202 one or more neighbor cells 106. The one or more neighbor cells 106 may be of the same radio access technology as the serving cell 104. For example, the one or more neighbor cells 106 may be part of the GSM network.

The wireless communication device 102 may determine 204 that reselection criteria 110 is met for a target cell. One or more control channels may be used to determine the reselection criteria 110. This may be accomplished as described above in connection with FIG. 1. For example, the wireless communication device 102 may determine 204 that the C2 criterion for a neighbor cell 106 is greater than the C2 criterion for the serving cell 104. The neighbor cell 106 may then be designated as a target cell for reselection.

The wireless communication device 102 may start 206 a reselection timer 112 for the target cell. In one configuration, the reselection timer 112 may be a 5 second timer. However, it is understood that the reselection timer 112 may be any length of time greater than or less than 5 seconds.

Upon expiration of the reselection timer 112, the wireless communication device 102 may determine 208 whether to perform reselection to the target cell based on the target cell SNR 114 and the serving cell SNR. If the wireless communication device 102 determines that the reselection criteria 110 for the target cell is still met upon expiration of the reselection timer 112, then the target cell is a candidate for reselection.

In one configuration, the wireless communication device 102 may measure the target cell SNR 114 by decoding a nearest burst of the target cell. The wireless communication device 102 may add a penalty time to the reselection timer 112 if the target cell SNR 114 is less than the serving cell SNR and a defined SNR threshold. This may be accomplished as described below in connection with FIG. 4. The wireless communication device 102 may then continue to monitor the target cell SNR 114 during the penalty time. If the wireless communication device 102 determines that the target cell SNR 114 is greater than the serving cell SNR and a defined SNR threshold, then the wireless communication device 102 may perform reselection to the target cell.

In another configuration, upon expiration of the reselection timer 112 for a target cell, the wireless communication device 102 may acquire the target cell SNR 114 by decoding an immediately available control channel of the target cell. The wireless communication device 102 may perform reselection to the target cell if the target cell SNR 114 is above a threshold of the serving cell SNR.

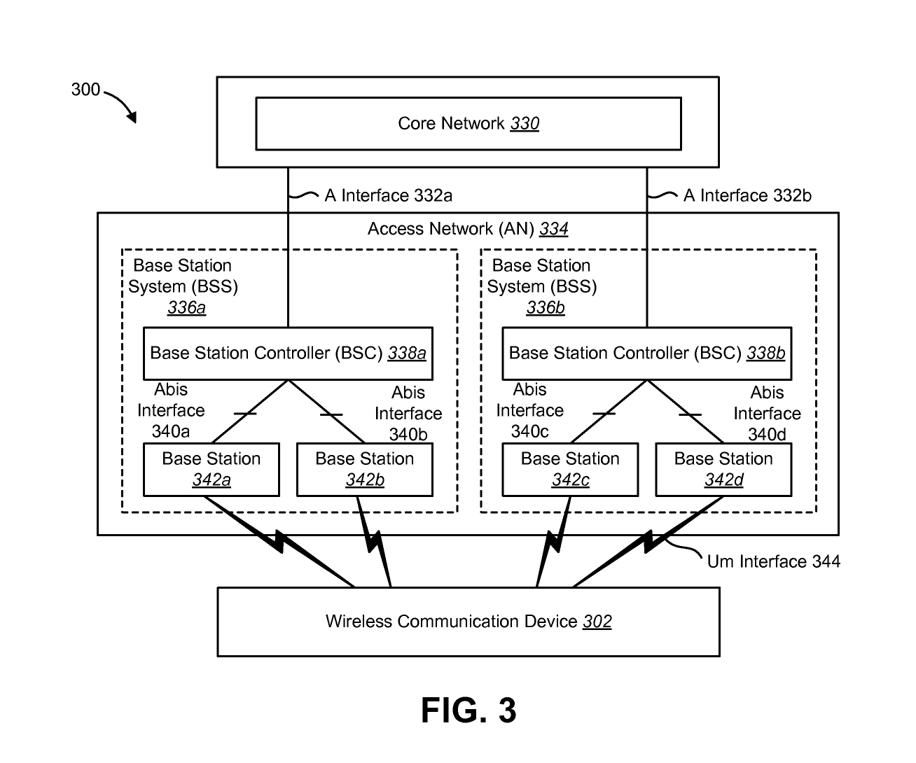

FIG. 3 is a block diagram illustrating a radio network 300 operating in accordance with the described systems and methods. The radio network 300 may operate according to Global System for Mobile Communications (GSM) standards and may be referred to as a GSM network. A GSM network is a collective term for the base stations 342a-d and the control equipment for the base stations 342a-d (e.g., base station controllers (BSCs) 338a-b) the GSM network may contain, which make up the access network (AN) 334. The GSM network provides an air interface access method for the wireless communication device 302. Connectivity is provided between the wireless communication device 302 and the core network 330 by the GSM network. The access network (AN) 334 may transport data packets between multiple wireless communication devices 302.

The GSM network is connected internally or externally to other functional entities by various interfaces (e.g., an A interface 332a-b, an Abis interface 340a-d, and a Um interface 344). The GSM network is attached to a core network 330 via an external interface (e.g., an A interface 332a-b). The base station controllers (BSCs) 338a-b support this interface. In addition, the base station controllers (BSCs) 338a-b manage a set of base stations 342a-d through Abis interfaces 340a-d. A base station controller (BSC) 338a and the managed base stations 342a-b form a base station system (BSS) 336a. A base station controller (BSC) 338b and the managed base stations 342c-d form a base station system (BSS) 336b. The Um interface 344 connects a base station 342 with a wireless communication device 302, while the Abis interface 340 is an internal interface connecting the base station controller (BSC) 338 with the base station 342.

The radio network 300 may be further connected to additional networks outside the radio network 300, such as a corporate intranet, the Internet, or a conventional public switched telephone network. The radio network 300 may transport data packets between each wireless communication device 302 and such outside networks.

GSM is a widespread standard in cellular, wireless communication. GSM is relatively efficient for standard voice services. However, high-fidelity audio and data services may require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 342 (the Ater and Abis interfaces 340) and the base station controllers (A interfaces 332, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, for uplink communication, GSM-900 commonly uses a radio spectrum in the 890-915 megahertz (MHz) bands (Mobile Station to Base Transceiver Station). For downlink communication, GSM-900 uses 935-960 MHz bands (base station 342 to wireless communication device 302). Furthermore, each frequency band is divided into 200 kHz carrier frequencies providing 124 RF channels spaced at 200 kHz. GSM-1900 uses the 1850-1910 MHz bands for the uplink and 1930-1990 MHz bands for the downlink Like GSM-900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

Each channel in GSM is identified by a specific absolute radio frequency channel (ARFCN). For example, ARFCN 1-124 are assigned to the channels of GSM-900, while ARFCN 512-810 are assigned to the channels of GSM-1900. Similarly, ARFCN 128-251 are assigned to the channels of GSM-850, while ARFCN 512-885 are assigned to the channels of GSM-1800. Also, each base station 342 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 302 or user is assigned one or more time slot indices for the duration of a call. User-specific data for each wireless communication device 302 is sent in the time slot(s) assigned to that wireless communication device 302 and in TDMA frames used for the traffic channels.

FIG. 4 is a block diagram illustrating a configuration of a wireless communication system 400 for performing enhanced cell reselection. The wireless communication system 400 may be a GSM network as described above in connection with FIG. 3. A wireless communication device 402 may be camped on a serving cell 404.

While camped on the serving cell 404, the wireless communication device 402 may monitor one or more neighbor cells 406 for reselection. For example, the wireless communication device 402 may determine whether reselection criteria 410 is met for a target cell. The reselection criteria 410 may include a C1 criterion and/or a C2 criterion.

As described above, the reselection criteria 410 may not account for interference experienced by a neighbor cell 406. For example, the reselection criteria 410 may not consider the target cell SNR 414.

To improve reselections, the wireless communication device 402 may perform enhanced cell reselection. In particular, the enhanced cell reselection procedures described herein may be beneficial for C2-based reselection. The wireless communication device 402 may include a target cell reselection module 408, a burst decoding module 416 and a penalty time determination module 418.

If the wireless communication device 402 determines that reselection criteria 410 is met for a target cell, the target cell reselection module 408 may start a reselection timer 412 for the target cell. Once the reselection timer 412 starts on a target cell (e.g., the best neighbor cell 406 based on the reselection criteria 410 determination), a burst decoding module 416 may measure the target cell SNR 414 on a nearest burst of the target cell for at least one discontinuous reception (DRX) cycle of the serving cell 404. In other words, the burst decoding module 416 may decode one nearest available burst of a neighbor cell 406 that is selected as the target cell during every paging channel (PCH) decode on the serving cell 404 to obtain the target cell SNR 414. The process of decoding the nearest available burst may add a latency of a maximum of 4.615 milliseconds (ms) to the PCH decode cycle. In one configuration, the burst decoding module 416 may measure the target cell SNR 414 every DRX cycle of the serving cell 404 for the duration of the reselection timer 412.

In one configuration, after the burst decoding module 416 attempts to decode the burst data of the neighbor cell 406 or serving cell 404, upon burst-level decoding, the burst decoding module 416 will also be able to calculate the SNR by performing correlation with a training sequence code. Each cell has a unique training sequence code associated with it. The SNR may be calculated by the burst decoding module 416 upon any burst decoding.

A penalty time determination module 418 may determine whether to add a penalty time 420 based on the target cell SNR 414. The penalty time determination module 418 may determine whether the target cell SNR 414 is greater than the serving cell SNR 424. If the target cell SNR 414 is greater than the serving cell SNR 424, then the penalty time determination module 418 may also determine whether the target cell SNR 414 is greater than an SNR threshold 422. In one configuration, the SNR threshold may be 6 decibels (dB). However, the SNR threshold 422 may be any suitable value greater than or less than 6 dB. If the target cell SNR 414 is greater than the SNR threshold 422, then the wireless communication device 402 may perform reselection to the target cell.

If the penalty time determination module 418 determines that the target cell SNR 414 is less than the serving cell SNR 424 or less than the SNR threshold 422 (e.g., SNR_Target<SNR_Threshold && SNR_Target<SNR_Serving), the penalty time determination module 418 may add a penalty time 420 to the reselection timer 412. In one configuration, the penalty time 420 may be the length of a discontinuous reception (DRX) cycle of the serving cell 404. For a 5 second reselection timer 412, the penalty time 420 may be expressed as Timer=5 sec timer+Drx_Cycle_length_Serving.

Adding the penalty time 420 to the reselection timer 412 may help the wireless communication device 402 determine the radio frequency (RF) conditions (e.g., low SNR, any interference, etc.) on an absolute radio frequency channel number (ARFCN) of a neighbor cell 406 for a considerable period of time. This may provide a more precise input of the target cell SNR 414 during reselection.

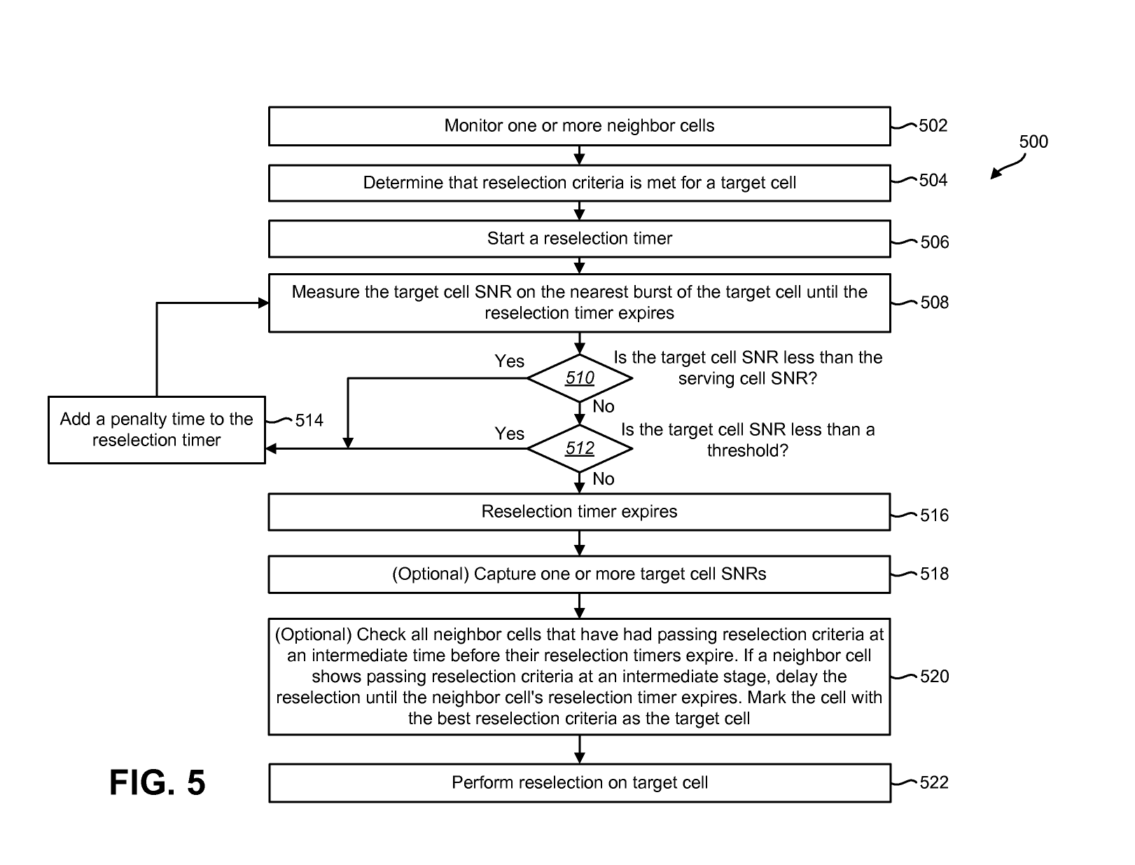

FIG. 5 is a flow diagram illustrating a detailed configuration of a method 500 for performing enhanced cell reselection. The method 500 may be performed by a wireless communication device 402. In one configuration, the wireless communication device 402 may operate on a GSM network as described above in connection with FIG. 3. The wireless communication device 402 may be camped on a serving cell 404.

The wireless communication device 402 may monitor 502 one or more neighbor cells 406. The one or more neighbor cells 406 may be of the same radio access technology as the serving cell 404. For example, the one or more neighbor cells 406 may be part of the GSM network.

The wireless communication device 402 may determine 504 that reselection criteria 410 is met for a target cell. For example, the wireless communication device 402 may determine that a C2 criterion for the target cell is greater than a C2 criterion for the serving cell 404. This may be accomplished as described above in connection with FIG. 1.

The wireless communication device 402 may start 506 a reselection timer 412 for the target cell. In one configuration, the reselection timer 412 may be a 5 second timer.

While the reselection timer 412 is running, the wireless communication device 402 may measure 508 the target cell SNR 414 on the nearest burst of the target cell until the reselection timer 412 expires. In one configuration, the wireless communication device 402 may measure 508 the target cell SNR 414 during a paging channel (PCH) decode on the serving cell 404.

The wireless communication device 402 may measure 508 the target cell SNR 414 on the nearest burst of the target cell for at least one discontinuous reception (DRX) cycle of the serving cell 404. In one configuration, the wireless communication device 402 may measure 508 the target cell SNR 414 on the nearest burst of the target cell every DRX cycle of the serving cell 404 for the duration of the reselection timer 412.

The wireless communication device 402 may determine 510 whether the target cell SNR 414 is less than or equal to the serving cell SNR 424. In one configuration, the wireless communication device 402 may determine 510 whether the target cell SNR 414 is less than or equal to the serving cell SNR 424 for every DRX cycle of the serving cell 404 that was monitored.

If the target cell SNR 414 is less than or equal to the serving cell SNR 424, then the wireless communication device 402 may add 514 a penalty time 420 to the reselection timer 412. In one configuration, the penalty time 420 may be the length of a DRX cycle of the serving cell 404. The wireless communication device 402 may then continue to measure 508 the target cell SNR 414 on the nearest burst of the target cell for the duration of the reselection timer 412.

If the wireless communication device 402 determines 510 that the target cell SNR 414 is not less than or equal to the serving cell SNR 424 (e.g., the target cell SNR 414 is greater than the serving cell SNR 424), then the wireless communication device 402 may determine 512 whether the target cell SNR 414 is less than or equal to an SNR threshold 422. The SNR threshold 422 may be 6 dB. In one configuration, the wireless communication device 402 may determine 512 whether the target cell SNR 414 is less than or equal to the SNR threshold 422 for every DRX cycle of the serving cell 404 that was monitored.

If the target cell SNR 414 is less than or equal to the SNR threshold 422, then the wireless communication device 402 may add 514 a penalty time 420 to the reselection timer 412. The wireless communication device 402 may then continue to measure 508 the target cell SNR 414 on the nearest burst of the target cell for the duration of the reselection timer 412.

If the wireless communication device 402 determines 512 that the target cell SNR 414 is not less than or equal to the SNR threshold 422 (e.g., the target cell SNR 414 is greater than the SNR threshold 422), then upon expiration 516 of the reselection timer 412, the wireless communication device 402 may perform additional optional steps (e.g., step 518 and/or step 520), or the wireless communication device 402 may perform 522 reselection on the target cell.

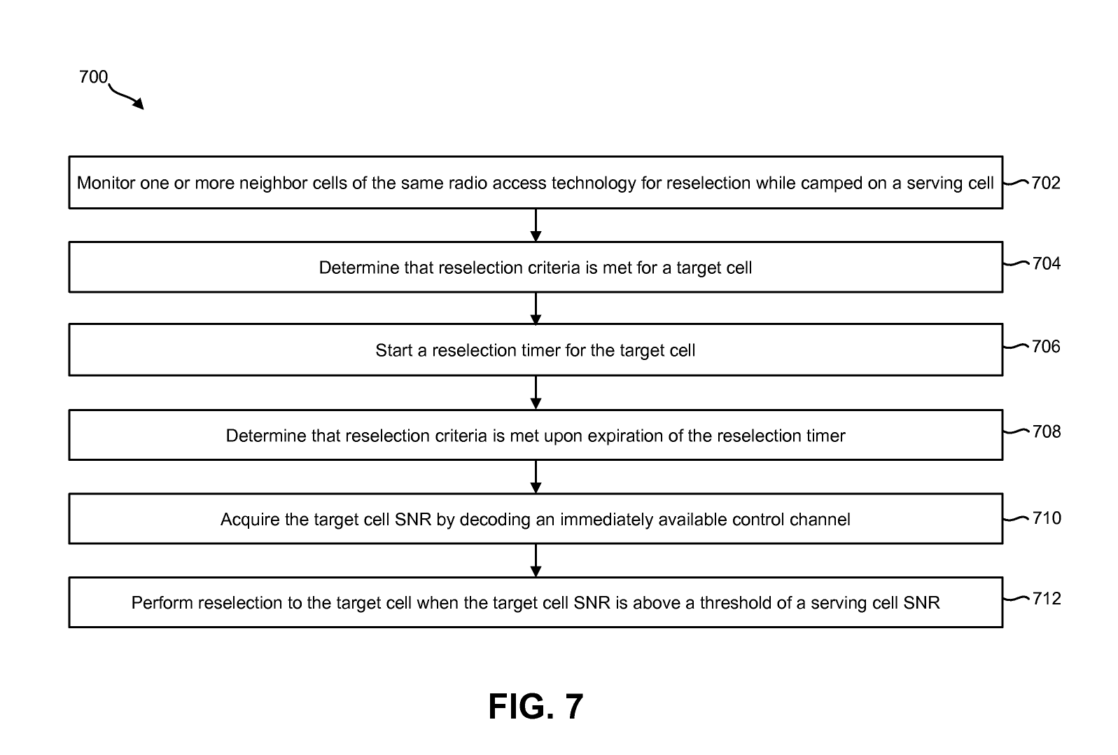

In one optional step, the wireless communication device 402 may capture 518 one or more target cell SNRs 414 after expiration of the reselection timer 412. In one configuration, the wireless communication device 402 may capture 518 the one or more target cell SNRs 414 by decoding an immediately available control channel. The wireless communication device 402 may determine whether to perform 522 reselection on the target cell based on whether the one or more target cell SNRs 414 are above a threshold of the serving cell SNR. This may be accomplished as described below in connection with FIG. 7.

In another optional step, the wireless communication device 402 may check 520 all the neighbor cells 406 that have shown passing reselection criteria 410 at an intermediate time before their reselection timers 412 expired. If any neighbor cell 406 (e.g., potential target cell) shows passing reselection criteria 410 at an intermediate stage (e.g., before reselection timer 412 expiration), the wireless communication device 402 may delay the reselection until expiration of the reselection timer 412 of the neighbor cell 406. The wireless communication device 402 may mark the cell with the best reselection criteria 410 as the target cell for reselection. The wireless communication device 402 may then perform 522 reselection to the target cell (e.g., the cell with the best reselection criteria 410). This step may be accomplished as described below in connection with FIG. 8.

FIG. 6 is a block diagram illustrating another configuration of a wireless communication system 600 for performing enhanced cell reselection. The wireless communication system 600 may be a GSM network as described above in connection with FIG. 3. A wireless communication device 602 may be camped on a serving cell 604.

While camped on the serving cell 604, the wireless communication device 602 may monitor one or more neighbor cells 606 for reselection. The one or more neighbor cells 606 may be of the same radio access technology as the serving cell 604. For example, the one or more neighbor cells 606 may be part of the GSM network.

The wireless communication device 602 may determine that reselection criteria 610 is met for a target cell. The reselection criteria 610 may include a C1 criterion and/or a C2 criterion. As described above, the reselection criteria 610 may not account for interference experienced by a neighbor cell 606. For example, the reselection criteria 610 may not consider the target cell SNR 614.

The wireless communication device 602 may include a target cell reselection module 608 and a control channel decoding module 626. If the wireless communication device 602 determines that reselection criteria 610 is met for a target cell, the target cell reselection module 608 may start a reselection timer 612 for the target cell.

Upon expiration of the reselection timer 612, if the reselection criteria 610 is still met for the target cell, then the control channel decoding module 626 may decode any immediately available control channel on the target cell. The control channel on the target cell may be at least one of a broadcast control channel (BCCH) or a common control channel (CCCH). The control channel may be included in the time slot 0 (TS0) on the target cell. Upon decoding the control channel on the target cell, the wireless communication device 602 may obtain the target cell SNR 614. The wireless communication device 602 may obtain the target cell SNR 614 may obtain the target cell SNR 614 as described above, in connection with FIG. 4.

The target cell reselection module 608 may take the target cell SNR 614 into consideration for the reselection procedure. If the target cell SNR 614 is good enough for control channel (e.g., BCCH/CCCH) decoding, the wireless communication device 602 may perform reselection to the target cell. In one configuration, the target cell reselection module 608 may determine whether the target cell SNR 614 is above (e.g., greater than) a threshold 646 of a serving cell SNR 628. In one example, the value of the threshold 646 of the serving cell SNR 628 may be 6 dB. However, the threshold 646 may be any suitable value greater than or less than 6 dB.

If the target cell SNR 614 is not good enough for control channel decoding (e.g., if the target cell SNR 614 is less than a threshold 646 of the serving cell SNR 628), then the wireless communication device 602 may consider performing reselection to the next best neighbor cell 606 upon expiration of the reselection timer 612 on the next best cell neighbor cell 606.

FIG. 7 is a flow diagram illustrating another detailed configuration of a method 700 for performing enhanced cell reselection. The method 700 may be performed by a wireless communication device 602. In one configuration, the wireless communication device 602 may operate on a GSM network as described above in connection with FIG. 3. The wireless communication device 602 may be camped on a serving cell 604.

The wireless communication device 602 may monitor 702 one or more neighbor cells 606. The one or more neighbor cells 606 may be of the same radio access technology as the serving cell 604. For example, the one or more neighbor cells 606 may be part of the GSM network.

The wireless communication device 602 may determine 704 that reselection criteria 610 is met for a target cell. For example, the wireless communication device 602 may determine that a C2 criterion for the target cell is greater than a C2 criterion for the serving cell 604. This may be accomplished as described above in connection with FIG. 1.

The wireless communication device 602 may start 706 a reselection timer 612 for the target cell. In one configuration, the reselection timer 612 may be a 5 second timer.

The wireless communication device 602 may determine 708 that reselection criteria 610 is met upon expiration of the reselection timer 612. In other words, the wireless communication device 602 may determine 708 that the reselection criteria 610 is met for the duration of the reselection timer 612.

The wireless communication device 602 may acquire 710 the target cell SNR 614 by decoding an immediately available control channel on the target cell. The control channel on the target cell may be at least one of a broadcast control channel (BCCH) or a common control channel (CCCH). The control channel may be included in the time slot 0 (TS0) on the target cell. Upon decoding the control channel on the target cell, the wireless communication device 602 may acquire 710 the target cell SNR 614.

The wireless communication device 602 may perform 712 reselection to the target cell when the target cell SNR 614 is above a threshold 646 of the serving cell SNR 628. The wireless communication device 602 may determine whether the target cell SNR 614 is above (e.g., greater than) a threshold 646 of a serving cell SNR 628. If the target cell SNR 614 is above a threshold 646 of the serving cell SNR 628, then the target cell SNR 614 may be good enough for control channel (e.g., BCCH/CCCH) decoding. In this case, the wireless communication device 602 may perform 712 reselection to the target cell.

If the target cell SNR 614 is less than a threshold 646 of the serving cell SNR 628, then the target cell SNR 614 may not be good enough for control channel decoding. In this case, the wireless communication device 602 may consider the next best neighbor cell 606 for reselection upon expiration of the reselection timer 612 on the next best neighbor cell 606.

FIG. 8 is a flow diagram illustrating yet another detailed configuration of a method 800 for performing enhanced cell reselection. The method 800 may be performed by a wireless communication device 102. In one configuration, the wireless communication device 102 may operate on a GSM network as described above in connection with FIG. 3. The wireless communication device 102 may be camped on a serving cell 104.

As described above, according to one approach for cell reselection in GSM networks, the neighbor cell 106 that has a higher reselection criteria 110 (e.g., C1/C2) value than the serving cell 104 may be considered for reselection. In one implementation, reselection is triggered after expiration of a reselection timer 112 of a neighbor cell 106 that is continuously maintaining a higher C2 value than the serving cell 104 for the duration of the reselection timer 112. The reselection timer 112 may be a 5 second timer.

In one scenario, reselection timers 112 may be running on more than one neighbor cell 106. In this scenario, the neighbor cell 106 that is preferred for reselection is the neighbor cell 106 for which the reselection timer 112 was first started (e.g., the first neighbor cell 106). The reselection criteria 110 (e.g., C1 and/or C2) may be calculated as described above in connection with FIG. 1. According to one approach for a cell reselection procedure, reselection is triggered on the neighbor cell 106 for which the reselection timer 112 has expired first. In other words, such an approach to a cell reselection procedure does not consider the current C2 value of other neighbor cells 106 with running reselection timers 112 that started after the first neighbor cell 106.

In one example, a serving cell 104 may be referred to as “A” and two neighbor cells 106 may be referred to as “B” and “C”, respectively. At a time X, the C2 value of neighbor cell B is greater than the C2 value of serving cell A (e.g., B(C2)>A(C2) at t=X). The reselection timer 112 for neighbor cell B may be started at time X. In the next DRX cycle (e.g., 0.47 sec) the C2 value for neighbor cell C also becomes greater than the C2 value of serving cell A (e.g., C(C2)>A(C2) at t=X+0.47 sec). The reselection timer 112 for neighbor cell C may be started at time X+0.47 sec. At time X+5 sec, the C2 value of neighbor cell C has become greater than the C2 value of neighbor B (e.g., C(C2)>B(C2)>A(C2)). Upon expiration of the reselection timer 112 for neighbor B at time X+5 sec, the reselection timer 112 for neighbor C is still running. Based on the above-mentioned approach for a cell reselection procedure, the reselection will be triggered for target cell B even though it is not the best neighbor cell 106 in the neighbor list. This may degrade the performance of the wireless communication device 102, particularly under mobility conditions (e.g., when the wireless communication device 102 is moving).

To overcome the problems of bad decision-making at the time of reselection, the wireless communication device 102 may keep some equilibrium on when the reselection timer 112 is expiring and the current reselection criteria 110 (e.g., C2) value of other neighbor cells 106 in order to determine the target cell for reselection. In one configuration, the wireless communication device 102 may determine 802 that the reselection timer 112 for the target cell has expired. In this case, the target cell may be the first neighbor cell 106 for which the reselection timer 112 was first started. A reselection timer 112 for one or more other neighbor cells 106 may have started running after the reselection timer 112 of the first neighbor cell 106.

The wireless communication device 102 may compare 804 reselection criteria 110 for at least one other neighbor cell 106 that has a running reselection timer 112 that has elapsed more than an intermediate time. The comparison 804 may be in response to determining that the reselection timer 112 for the target cell has expired. A variable for the intermediate time (T_{Intermediate}) may be used to compare 804 reselection criteria 110 for at least one other neighbor cell 106. Upon expiration of the reselection timer 112 on any neighbor cell 106, the wireless communication device 102 may check if there are other neighbor cells 106 on which a reselection timer 112 is running. If a neighbor cell 106 reselection timer 112 has elapsed more than T_{Intermediate}, the wireless communication device 102 may consider that neighbor cell 106 for reselection. In another configuration, the wireless communication device 102 may compare 804 the target cell SNR 114 for the target cell with a neighbor cell SNR for at least one other neighbor cell 106 that has a running reselection timer 112 that has elapsed more than an intermediate time.

In one configuration, the value for T_{Intermediate} is 2.5 seconds. It should be noted that the value for T_{Intermediate} may be adjusted to find an optimum value that can be greater than or less than 2.5 seconds.

The wireless communication device 102 may determine 806 whether to perform reselection to the target cell or a neighbor cell 106 based on the comparison 804. In one configuration, the wireless communication device 102 may perform reselection to the target cell or a neighbor cell 106 with the highest reselection criteria 110. In other words, the wireless communication device 102 may perform reselection to the target cell or a neighbor cell 106 that has the highest reselection criteria 110, not just the neighbor cell 106 whose reselection timer 112 expires first. In one configuration, the wireless communication device 102 may perform reselection to the neighbor cell 106 with the highest reselection criteria 110 upon considering the SNR of the neighbor cell 106, as described above in connection with FIG. 4 and FIG. 6. In another configuration, the wireless communication device 102 may perform reselection to the target cell or a neighbor cell 106 with the highest SNR.

In one example of a wireless communication device 102 performing enhanced cell reselection, the C2 value of neighbor cell B is greater than the C2 value of serving cell A at time X (e.g., B(C2)>A(C2) at t=X). The reselection timer 112 is started for neighbor cell B at time X. In the next DRX cycle, the C2 value for neighbor cell C also becomes greater than serving cell A (e.g., C(C2)>A(C2) at t=X+0.470 sec). The reselection timer 112 is started for neighbor cell C at time X+0.47 sec. At time X+5 sec, the C2 value of neighbor cell C has become greater than the C2 value of neighbor cell B (e.g., C(C2)>B(C2)>A(C2)). The reselection timer 112 is still running for neighbor cell C with an elapsed timer of 4.53 sec. Because the elapsed time on neighbor cell C is greater than T_{Intermediate} (e.g., 2.5 seconds), the wireless communication device 102 may consider both neighbor cells B and C for reselection. In this case, the wireless communication device 102 will perform reselection to neighbor cell C because it has the highest reselection criteria 110 (e.g., C2 value).

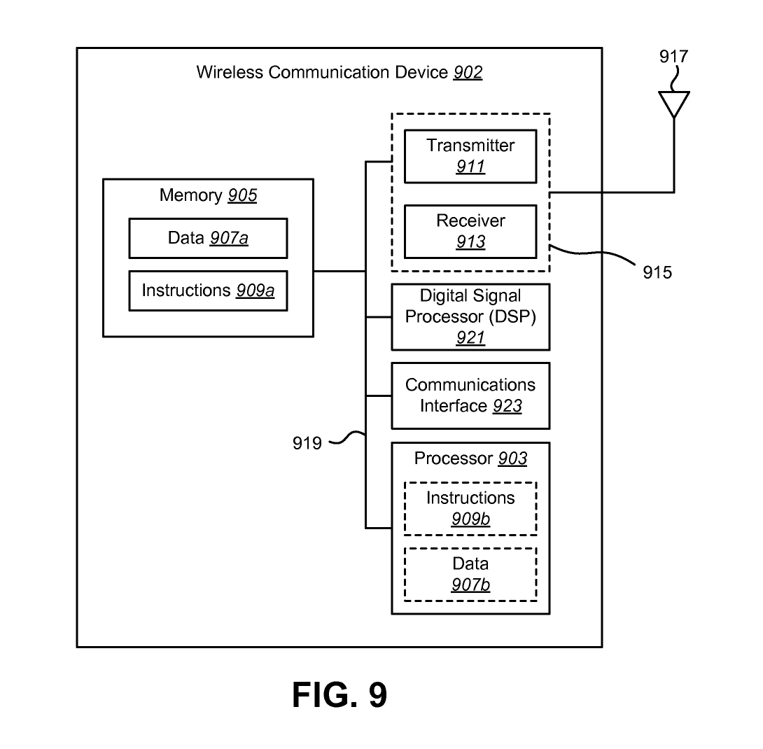

FIG. 9 illustrates certain components that may be included within a wireless communication device 902. The wireless communication device 902 may be an access terminal, a mobile station, a user equipment (UE), etc. For example, the wireless communication device 902 may be the wireless communication device 102 of FIG. 1.

The wireless communication device 902 includes a processor 903. The processor 903 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 902 of FIG. 9, in an alternative configuration, a combination of processors (e.g., an ARM and DSP) could be used.

The wireless communication device 902 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909, various portions of the instructions 909b may be loaded onto the processor 903, and various pieces of data 907b may be loaded onto the processor 903.

The wireless communication device 902 may also include a transmitter 911 and a receiver 913 to allow transmission and reception of signals to and from the wireless communication device 902 via an antenna 917. The transmitter 911 and receiver 913 may be collectively referred to as a transceiver 915. The wireless communication device 902 may also include (not shown) multiple transmitters, multiple antennas, multiple receivers and/or multiple transceivers.

The wireless communication device 902 may include a digital signal processor (DSP) 921. The wireless communication device 902 may also include a communications interface 923. The communications interface 923 may allow a user to interact with the wireless communication device 902.

The various components of the wireless communication device 902 may be coupled together by one or more buses, which may include a power bus, a control signal bus, a status signal bus, a data bus, etc. For the sake of clarity, the various buses are illustrated in FIG. 9 as a bus system 919.

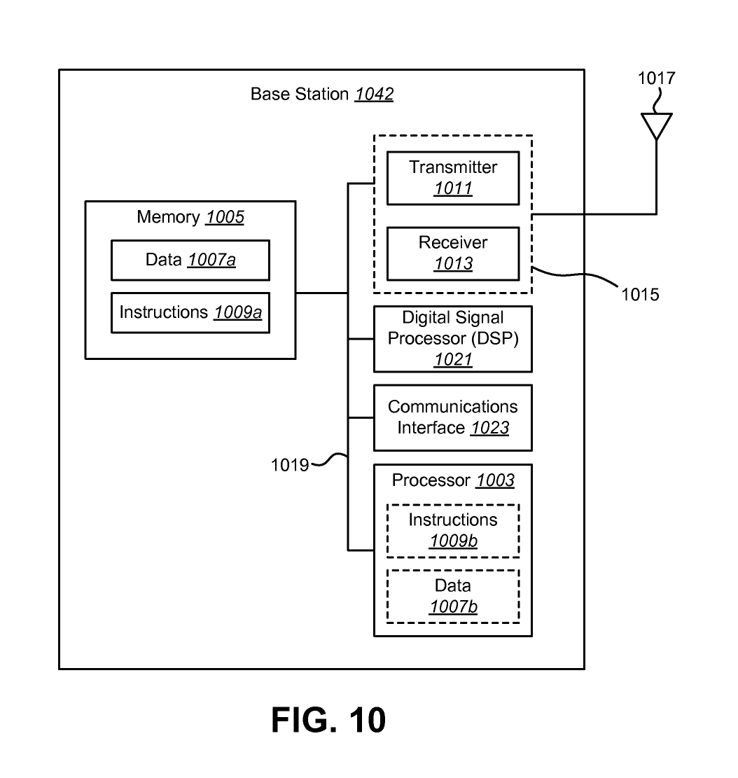

FIG. 10 illustrates certain components that may be included within a base station 1042. A base station 1042 may also be referred to as, and may include some or all of the functionality of, an access point, a broadcast transmitter, a NodeB, an evolved NodeB, etc. For example, the base station 1042 may be the base station 342 of FIG. 3.

The base station 1042 may include a processor 1003. The processor 1003 may be a general purpose single- or multi-chip microprocessor (e.g., an ARM), a special purpose microprocessor (e.g., a digital signal processor (DSP)), a microcontroller, a programmable gate array, etc. The processor 1003 may be referred to as a central processing unit (CPU). Although just a single processor 1003 is shown in the base station 1042 of FIG. 10, in an alternative configuration, a combination of processors (e.g., an ARM and DSP) could be used.

The base station 1042 also includes memory 1005. The memory 1005 may be any electronic component capable of storing electronic information. The memory 1005 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1007a and instructions 1009a may be stored in the memory 1005. The instructions 1009a may be executable by the processor 1003 to implement the methods disclosed herein. Executing the instructions 1009a may involve the use of the data 1007a that is stored in the memory 1005. When the processor 1003 executes the instructions 1009a, various portions of the instructions 1009b may be loaded onto the processor 1003, and various pieces of data 1007b may be loaded onto the processor 1003.

The base station 1042 may also include a transmitter 1011 and a receiver 1013 to allow transmission and reception of signals to and from the base station 1042. The transmitter 1011 and receiver 1013 may be collectively referred to as a transceiver 1015. An antenna 1017 may be electrically coupled to the transceiver 1015. The base station 1042 may also include (not shown) multiple transmitters, multiple receivers, multiple transceivers and/or additional antennas.

The base station 1042 may include a digital signal processor (DSP) 1021. The base station 1042 may also include a communications interface 1023. The communications interface 1023 may allow a user to interact with the base station 1042.

The various components of the base station 1042 may be coupled together by one or more buses, which may include a power bus, a control signal bus, a status signal bus, a data bus, etc. For the sake of clarity, the various buses are illustrated in FIG. 10 as a bus system 1019.

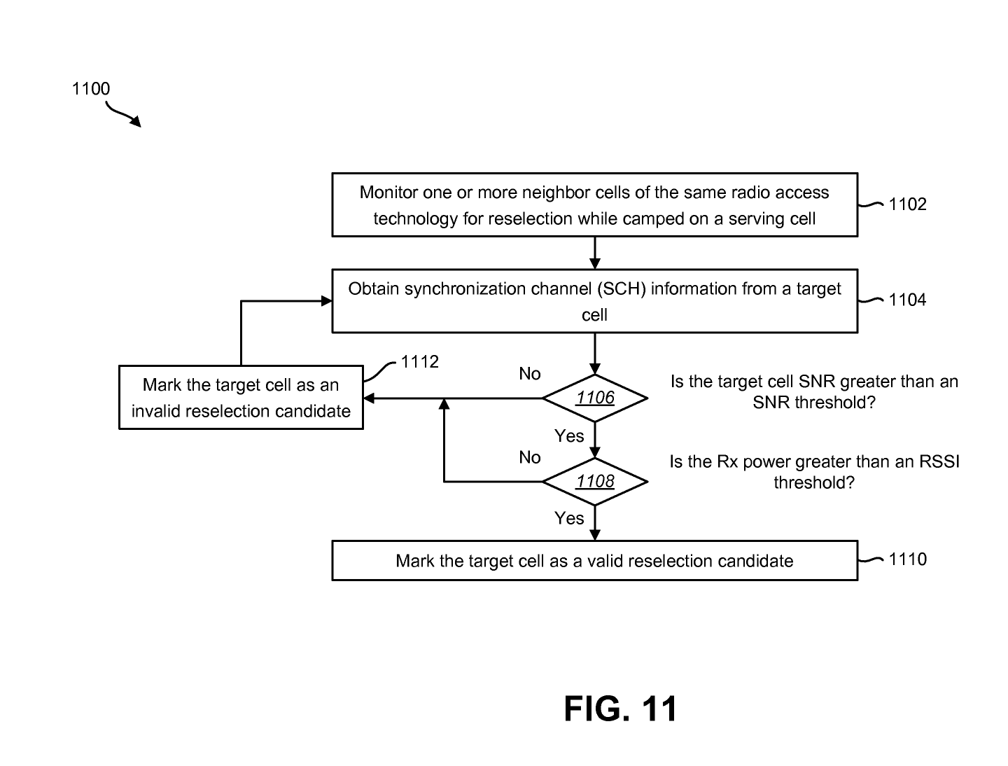

FIG. 11 is a flow diagram illustrating a method 1100 for performing enhanced cell reselection based on a target cell SNR and receive (Rx) power. The method 1100 may be performed by a wireless communication device 102. In one configuration, the wireless communication device 102 may operate on a GSM network as described above in connection with FIG. 3.

The wireless communication device 102 may be camped on a serving cell 104. In some scenarios, the wireless communication device 102 may be in an idle mode or packet transfer mode (PTM). Cell reselection to a cell that is limited by interference (e.g., an interference-limited cell) may lead to degraded data throughput; poor mobile originated (MO) and/or mobile terminated (MT) voice call performance; out of service conditions; and/or frequent reselections and hand-overs. By evaluating quality metrics associated with a target cell, the wireless communication device 102 may avoid reselection to an interference-limited neighbor cell 106.

The wireless communication device 102 may monitor 1102 one or more neighbor cells 106. The one or more neighbor cells 106 may be of the same radio access technology as the serving cell 104. For example, the one or more neighbor cells 106 may be part of the GSM network.

The wireless communication device 102 may obtain 1104 synchronization channel (SCH) information from a target cell. The SCH information may include the target cell SNR 114 and the Rx power of the target cell. In one configuration, the wireless communication device 102 may obtain the target cell SNR 114 and the Rx power upon decoding a SCH burst. The SCH may be a downlink control channel. The SCH burst may include a training sequence code. The target cell SNR 114 and the Rx power may be calculated by performing correlation with the training sequence code. The Rx power may also be referred to as a received signal strength indicator (RSSI), which may be a measurement of the power present in a received radio signal.

The wireless communication device 102 may determine 1106 whether the target cell SNR 114 is greater than an SNR threshold. If the target cell SNR 114 is greater than the SNR threshold, then the wireless communication device 102 may determine 1108 whether the Rx power is greater than a received signal strength indicator (RSSI) threshold. If the Rx power is greater than the RSSI threshold, then the wireless communication device 102 may mark 1110 the target cell as a reselection candidate. In other words, if the target cell shows metrics (e.g., the target cell SNR 114 and Rx power) above set thresholds, then the target cell may be marked as a valid reselection candidate.

If the wireless communication device 102 determines 1106 that the target cell SNR 114 is not greater than an SNR threshold, or if the wireless communication device 102 determines 1108 that the Rx power is not greater than an RSSI threshold, then the wireless communication device 102 may mark 1112 the target cell as an invalid reselection candidate. The wireless communication device 102 may re-obtain 1104 SCH information from the target cell until the quality metrics satisfy the passing criteria. In one configuration, the wireless communication device 102 may perform a reconfirmation procedure of the target cell to re-obtain 1104 the target cell SNR 114 and Rx power. The wireless communication device 102 may then reevaluate whether the target cell SNR 114 and Rx power are greater than the set thresholds.

The wireless communication device 102 may reevaluate whether the quality metrics satisfy the passing criteria for a set period of time. In one configuration, if either the target cell SNR 114 or the Rx power the wireless communication device 102 is less than the set thresholds, then the wireless communication device 102 may perform a certain number or reconfirmation procedures to re-obtain 1104 SCH information from the target cell. If the quality metrics fail to satisfy the passing criteria after the set period of time, then the wireless communication device 102 may schedule a combined acquisition of the target cell.

The wireless communication device 102 may notify higher layers (e.g., the radio resource (RR) sublayer) of the valid/invalid reselection candidate status of a target cell. The higher layers may make the final reselection decision. It should be noted that while a single target cell is described in this method 1100, the wireless communication device 102 may evaluate the quality metrics (e.g., the target cell SNR 114 and the Rx power) of each monitored neighbor cell 106 to determine a reselection candidate. Therefore, the wireless communication device 102 may filter the target cell candidates by checking the RSSI and SNR of each neighbor cell 106.

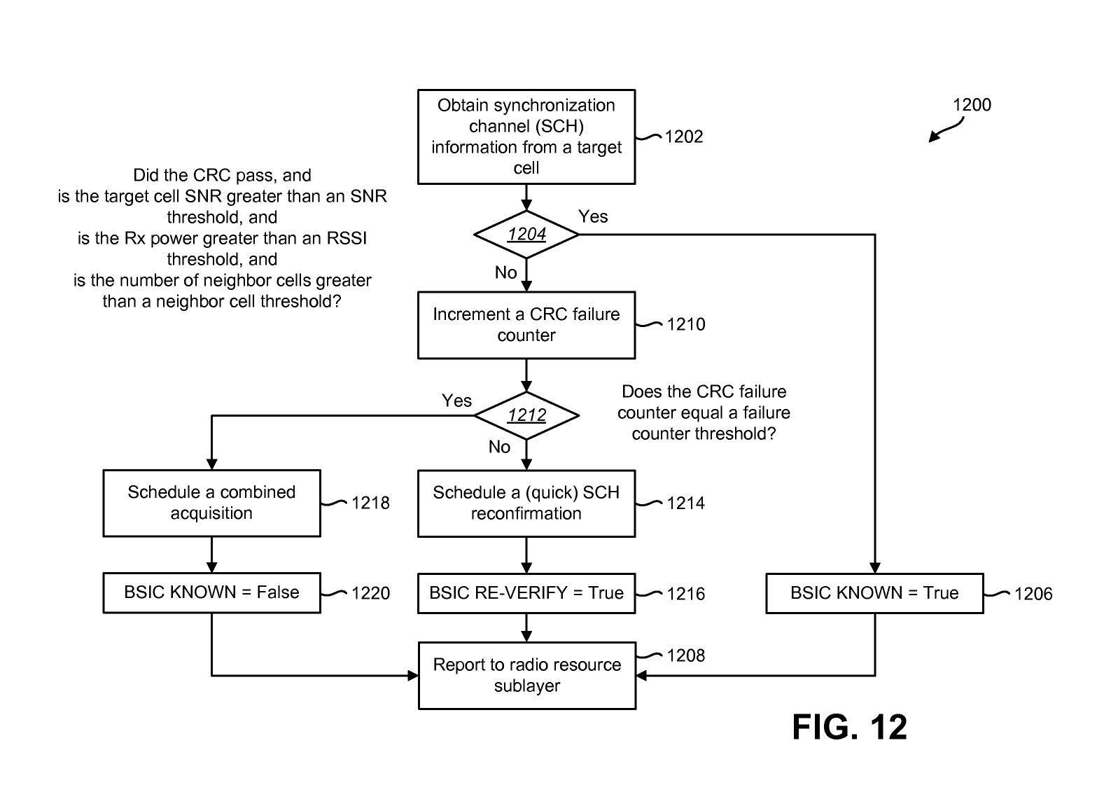

FIG. 12 is a flow diagram illustrating a more detailed configuration of a method 1200 for performing enhanced cell reselection based on a target cell SNR and receive (Rx) power. The method 1200 may be performed by a wireless communication device 102. In one configuration, the wireless communication device 102 may operate on a GSM network as described above in connection with FIG. 3.

The wireless communication device 102 may be camped on a serving cell 104. In some scenarios, the wireless communication device 102 may be in an idle mode or packet transfer mode (PTM). The wireless communication device 102 may obtain 1202 synchronization channel (SCH) information from a target cell. The SCH information may include the target cell SNR 114 and the Rx power of the target cell. The wireless communication device 102 may obtain the SCH information by decoding the SCH of a target cell.

The wireless communication device 102 may determine 1204 whether quality metrics for the target cell satisfy passing criteria. In one configuration, the wireless communication device 102 may determine 1204 whether the SCH decoding passes a cyclic redundancy check (CRC). The wireless communication device 102 may also determine 1204 whether the target cell SNR 114 is greater than an SNR threshold. The wireless communication device 102 may further determine 1204 whether the Rx power of the target cell is greater than a received signal strength indicator (RSSI) threshold. The wireless communication device 102 may additionally determine 1204 whether the number of neighbor cells 106 is greater than a neighbor cell threshold.

If the quality metrics of the target cell satisfy the passing criteria, then the wireless communication device 102 may set 1206 a base station identity code (BSIC) KNOWN indicator to TRUE, which may indicate that the target cell is a valid candidate for reselection. The wireless communication device 102 may report 1208 the valid reselection candidate status of the target cell to the radio resource (RR) sublayer, which may make the final reselection decision.

If the wireless communication device 102 determines 1204 that the quality metrics of the target cell do not satisfy the passing criteria, the wireless communication device 102 may increment 1210 a CRC failure counter. The wireless communication device 102 may determine 1212 whether the CRC failure counter equals a failure counter threshold.

If the wireless communication device 102 determines 1212 that the CRC failure counter is less than (e.g., does not equal) the failure counter threshold, then the wireless communication device 102 may schedule 1214 a quick SCH reconfirmation procedure. The wireless communication device 102 may set 1216 a BSIC RE-VERIFY indicator to TRUE, which may indicate that the target cell is an invalid reselection candidate. The wireless communication device 102 may report 1208 the invalid reselection candidate status of the target cell to the radio resource (RR) sublayer. The RR sublayer may then initiate the reconfirmation procedure.

If the wireless communication device 102 determines 1212 that the CRC failure counter is equal to the failure counter threshold, then the wireless communication device 102 may schedule 1218 a combined acquisition procedure. The wireless communication device 102 may set 1220 a BSIC KNOWN indicator to FALSE, which may indicate that the target cell is an invalid reselection candidate. The wireless communication device 102 may report 1208 the invalid reselection candidate status of the target cell to the radio resource (RR) sublayer. The RR sublayer may then initiate the combined acquisition procedure.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 5, FIG. 7, FIG. 8 and FIG. 11 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for performing cell reselection by a wireless communication device, comprising:
monitoring one or more neighbor cells of a same radio access technology as a serving cell while camped on the serving cell;
determining that reselection criteria is met for a target cell;
starting a reselection timer for the target cell; and
determining whether to perform reselection to the target cell based on a target cell signal to noise ratio (SNR) and a serving cell SNR.

2. The method of claim 1, wherein a neighbor cell comprises the target cell.

3. The method of claim 1, wherein the radio access technology is Global System for Mobile Communications (GSM).

4. The method of claim 1, wherein the reselection criteria is based on at least one of a C1 criterion and a C2 criterion.

5. The method of claim 1, further comprising measuring the target cell SNR on a nearest burst of the target cell for at least one discontinuous reception (DRX) cycle of the serving cell.

6. The method of claim 5, further comprising measuring the target cell SNR during at least one paging channel (PCH) decode on the serving cell.

7. The method of claim 5, further comprising adding a penalty time to the reselection timer upon expiration of the reselection timer if the target cell SNR is less than a threshold or less than the serving cell SNR.

8. The method of claim 7, wherein the penalty time is a discontinuous reception (DRX) cycle length of the serving cell.

9. The method of claim 1, further comprising:
determining that reselection criteria is met upon expiration of the reselection timer; and
acquiring the target cell SNR by decoding an immediately available control channel.

10. The method of claim 9, further comprising performing reselection to the target cell when the target cell SNR is above a threshold of the serving cell SNR.

11. The method of claim 1, further comprising:
determining that the reselection timer for the target cell has expired;
comparing, in response to determining that the reselection timer for the target cell has expired, reselection criteria for the target cell with reselection criteria for at least one other neighbor cell that has a running reselection timer that has elapsed more than an intermediate time; and
determining whether to perform reselection to the target cell or the at least one other neighbor cell based on the comparison.

12. The method of claim 11, wherein determining whether to perform reselection to the target cell or the at least one other neighbor cell comprises determining to perform reselection to the target cell or the at least one other neighbor cell with the highest reselection criteria.

13. The method of claim 12, further comprising performing reselection to the target cell or the at least one other neighbor cell with the highest reselection criteria.

14. The method of claim 1, further comprising:
determining that the reselection timer for the target cell has expired;
comparing, in response to determining that the reselection timer for the target cell has expired, the target cell SNR for the target cell with a neighbor cell SNR for at least one other neighbor cell that has a running reselection timer that has elapsed more than an intermediate time; and
determining whether to perform reselection to the target cell or the at least one other neighbor cell based on the comparison.

15. The method of claim 1, further comprising:
determining whether the target cell SNR is greater than an SNR threshold;
determining whether a receive power of the target cell is greater than a received signal strength indicator (RSSI) threshold; and
marking the target cell as a reselection candidate if the target cell SNR is greater than the SNR threshold and the receive power of the target cell is greater than the RSSI threshold.

16. The method of claim 15, further comprising:
marking the target cell as an invalid reselection candidate if the target cell SNR is not greater than the SNR threshold or the receive power of the target cell is not greater than the RSSI threshold; and
reacquiring the target cell SNR and the receive power of the target cell for a set period of time.

17. The method of claim 1, wherein one or more control channels are used to determine the reselection criteria.

18. An apparatus for performing cell reselection, comprising:
a processor;
memory in electronic communication with the processor; and
instructions stored in the memory, the instructions being executable by the processor to:
monitor one or more neighbor cells of a same radio access technology as a serving cell while camped on the serving cell;
determine that reselection criteria is met for a target cell;
start a reselection timer for the target cell; and
determine whether to perform reselection to the target cell based on a target cell signal to noise ratio (SNR) and a serving cell SNR.

19. The apparatus of claim 18, further comprising instructions executable to add a penalty time to the reselection timer upon expiration of the reselection timer if the target cell SNR is less than a threshold or less than the serving cell SNR.

20. The apparatus of claim 18, further comprising instructions executable to:
determine that reselection criteria is met upon expiration of the reselection timer; and
acquire the target cell SNR by decoding an immediately available control channel.

21. The apparatus of claim 18, further comprising instructions executable to:
determine that the reselection timer for the target cell has expired;
compare, in response to determining that the reselection timer for the target cell has expired, reselection criteria for the target cell with reselection criteria for at least one other neighbor cell that has a running reselection timer that has elapsed more than an intermediate time; and
determine whether to perform reselection to the target cell or the at least one other neighbor cell based on the comparison.

22. The apparatus of claim 18, further comprising instructions executable to:
determine whether the target cell SNR is greater than an SNR threshold;
determine whether a receive power of the target cell is greater than a received signal strength indicator (RSSI) threshold; and
mark the target cell as a reselection candidate if the target cell SNR is greater than the SNR threshold and the receive power of the target cell is greater than the RSSI threshold.

23. A wireless communication device for performing cell reselection, comprising:
means for monitoring one or more neighbor cells of a same radio access technology as a serving cell while camped on the serving cell;
means for determining that reselection criteria is met for a target cell;
means for starting a reselection timer for the target cell; and
means for determining whether to perform reselection to the target cell based on a target cell signal to noise ratio (SNR) and a serving cell SNR.

24. The wireless communication device of claim 23, further comprising means for adding a penalty time to the reselection timer upon expiration of the reselection timer if the target cell SNR is less than a threshold or less than the serving cell SNR.

25. The wireless communication device of claim 23, further comprising:
means for determining that the reselection timer for the target cell has expired;
means for comparing, in response to determining that the reselection timer for the target cell has expired, reselection criteria for the target cell with reselection criteria for at least one other neighbor cell that has a running reselection timer that has elapsed more than an intermediate time; and
means for determining whether to perform reselection to the target cell or the at least one other neighbor cell based on the comparison.

26. The wireless communication device of claim 23, further comprising:
means for determining whether the target cell SNR is greater than an SNR threshold;
means for determining whether a receive power of the target cell is greater than a received signal strength indicator (RSSI) threshold; and
means for marking the target cell as a reselection candidate if the target cell SNR is greater than the SNR threshold and the receive power of the target cell is greater than the RSSI threshold.

27. A computer-program product for performing cell reselection, the computer-program product comprising a non-transitory computer-readable medium having instructions thereon, the instructions comprising:
code for causing a wireless communication device to monitor one or more neighbor cells of a same radio access technology as a serving cell while camped on the serving cell;
code for causing the wireless communication device to determine that reselection criteria is met for a target cell;
code for causing the wireless communication device to start a reselection timer for the target cell; and
code for causing the wireless communication device to determine whether to perform reselection to the target cell based on a target cell signal to noise ratio (SNR) and a serving cell SNR.

28. The computer-program product of claim 27, further comprising code for causing the wireless communication device to add a penalty time to the reselection timer upon expiration of the reselection timer if the target cell SNR is less than a threshold or less than the serving cell SNR.

29. The computer-program product of claim 27, further comprising:
code for causing the wireless communication device to determine that the reselection timer for the target cell has expired;
code for causing the wireless communication device to compare, in response to determining that the reselection timer for the target cell has expired, reselection criteria for the target cell with reselection criteria for at least one other neighbor cell that has a running reselection timer that has elapsed more than an intermediate time; and
code for causing the wireless communication device to determine whether to perform reselection to the target cell or the at least one other neighbor cell based on the comparison.

30. The computer-program product of claim 27, further comprising:
code for causing the wireless communication device to determine whether the target cell SNR is greater than an SNR threshold;
code for causing the wireless communication device to determine whether a receive power of the target cell is greater than a received signal strength indicator (RSSI) threshold; and
code for causing the wireless communication device to mark the target cell as a reselection candidate if the target cell SNR is greater than the SNR threshold and the receive power of the target cell is greater than the RSSI threshold.
